(19) United States
(12) Patent Application Publication
(10) Pub. No.: US 2009/0276505 A1
(43) Pub. Date: Nov. 5, 2009

(54) WEB SERVICE CONTROL APPARATUS AND METHOD

(75) Inventor: Yuji IMAI, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/497,905

(22) Filed: Jul. 6, 2009

Related U.S. Application Data
(63) Continuation of application No. PCT/JP2007/055378, filed on Mar. 16, 2007.

(51) Int. Cl. G06F 15/16

(52) U.S. Cl. 709/219

(57) ABSTRACT

A computer readable storage medium stores a Web service control program that allows a computer to execute a process comprising: receiving from a consumer of a reservation request for a reservation which reserves the Web service and defines a condition; acquiring a state of a server; determining whether to accept the reservation according to the condition and the state; accepting the reservation when it is determined to accept the reservation; transmitting a reply, when the reservation is accepted; detecting, when receiving a Web service request which includes first information based on a first communication protocol and second information based on a second communication protocol, the reservation identifier in the second information to determine according to result of the detecting whether or not the Web service request conforms to the reservation; and transferring the Web service request when the Web service request is determined to conform to the reservation.

### CROSS-REFERENCE TO RELATED APPLICATIONS

This application is a continuation application, filed under 35 U.S.C.§111 (a), of PCT Application No. PCT/JP2007/055378, filed Mar. 16, 2007, the disclosure of which is herein incorporated in its entirety by reference.

### FIELD

The embodiments discussed herein are related to a Web service control apparatus, a Web service control method, and a medium recording a Web service control program that control communication between a consumer and a provider in a Web service.

### BACKGROUND

In recent years, a new technical trend has emerged in an SOA (Service Oriented Architecture) that designs a system based on loosely-coupled services. In a conventional Web service system, a provider side estimates the amount of Web service requests that a consumer side will transmit and, based on its peak value, determines the total capacity of servers to be prepared.

Further, electronic negotiation technology such as WS (Web Service)-Agreement specification standardized by GGF (Global Grid Forum) has been proposed.

As a conventional art relating to the present invention, there is known a method and apparatus that manage business interaction between the parties. In addition, there is known a method that provides end-to-end service quality negotiation procedure for a distributed multimedia.
Patent Document 1: Japanese Laid-open Patent Publication No. 2006-146892
Patent Document 2: International Publication Pamphlet No. 2004-537187

However, in a conventional Web service system, an operator on the provider side estimates the Web service request amount without acquiring a clear utilization plan of each of customers on the consumer side. Further, in the case where the provider-side operator has failed in making the estimation of the Web service request amount, he or she needs to rearrange the installed capacity. Since these operations are carried out by the operator, man-hour may rise, as well as, there may be a risk of errors. Further, in the conventional Web service system, the provider-side operator conducts hearings with customers for planning addition of the installed capacity. However, in the case where the number of customers is greatly increased or the frequency of the hearings is increased, it becomes difficult for the operator to make the estimation.

Further, there may be a case where the provider side receives the number of requests exceeding the installed capacity. The provider cannot prevent such a case from occurring for technical and contractual reasons, so that servers provided on the provider side may become overloaded and even unstable.

Further, in the case of a Web service, unlike the case of a scientific computation service where estimation of required resources is easy, it is difficult to estimate the required resources due to existence of a case where the number of requests suddenly increases.

### SUMMARY

According to a aspect of the present invention, a computer readable storage medium stores a Web service control program that allows a computer to execute a process comprising: receiving from a consumer of a reservation request for a reservation which reserves the Web service and defines a condition for Web service requests for the Web service; acquiring a state of a server that can execute the Web service; determining whether or not to accept the reservation according to the condition and the state of the server; accepting the reservation when it is determined to accept the reservation; transmitting to the consumer, when the reservation is accepted, a reply including a reservation identifier indicating the accepted reservation; when receiving from the consumer a Web service request which includes first information based on a first communication protocol and second information based on a second communication protocol, detecting the reservation identifier in the second information to determine according to result of the detecting whether or not the Web service request conforms to the accepted reservation, a layer of the second communication protocol being lower than a layer of the first communication protocol; and transferring the received Web service request to the server when the received Web service request is determined to conform to the accepted reservation.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram depicting an example of a configuration of a Web service system according to an embodiment of the present invention;

FIG. 2 is a sequence diagram depicting an example of operation of the Web service system according to the present embodiment;

FIG. 3 is a table depicting an example of the content of a price list according to the present embodiment;

FIG. 4 is a table depicting a first example of a utilization plan table according to the present embodiment;

FIG. 5 is a table depicting a second example of the utilization plan table according to the present embodiment;

FIG. 6 is a view depicting an example of the content of a reservation request according to the present embodiment;

FIG. 7 is a view depicting an example of the content of a reservation reply according to the present embodiment;

FIG. 8 is a table depicting an example of the content of a provider reservation information table according to the present embodiment;

FIG. 9 is a table depicting an example of the content of a server information table according to the present embodiment;

FIG. 10 is a table depicting an example of the content of a consumer reservation information table according to the present embodiment;

FIG. 11 is a table depicting an example of the content of the passage determination information table according to the present embodiment;

FIG. 12 is a block diagram depicting an example of a configuration of a Web service system according to a second embodiment;

FIG. 13 is a sequence diagram depicting an example of operation of the Web service system according to the second embodiment;

FIG. 14 is a graph depicting an example of a service profile according to the second embodiment;

FIG. 15 is a sequence diagram depicting an example of operation of a Web service system according to a third embodiment;

FIG. 16 is a block diagram depicting an example of operation of a conventional load balancer;

FIG. 17 is a table depicting an example of a cookie table retained by the conventional load balancer;

FIG. 18 is a view depicting an example of a Web service request according to a fourth embodiment; and

FIG. 19 is a flowchart depicting an example of operation of a CK according to the fourth embodiment.

### DESCRIPTION OF EMBODIMENTS

An embodiment of the present invention will be described below with reference to the accompanying drawings.

### First Embodiment

A Web service in a Web service system according to the present embodiment is a service using Web Service/SOAP (Simple Object Access Protocol), REST (Representational State Transfer), HTTP (HyperText Transfer Protocol), and the like.

Further, in the present embodiment, a Web service system offering a stamp duty service will be described. In the stamp duty service, a provider side receives from a consumer side an electronic receipt issued through an electronic clearing system and appends a stamp duty (time stamp) to the electronic receipt. The consumer side that has received the service makes payment, to the provider, of a service fee charged by the provider together with the amount to be paid to the country. Hereinafter, this service is represented by a service type “TSService”, and functions offered by this service are represented by “stamp” and “check”.

First, a configuration of a Web service system according to the present embodiment will be described.

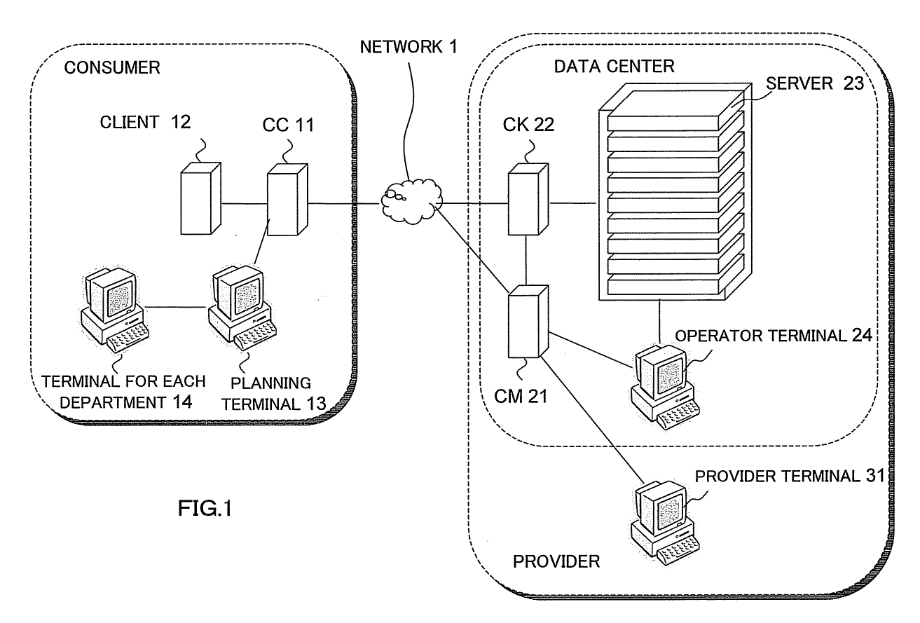

FIG. 1 is a block diagram depicting an example of a configuration of a Web service system according to the present embodiment. The Web service system has, on the consumer side, a CC (Contract Client) 11 (relay apparatus), one or more clients 12, a planning terminal 13, and a terminal 14 installed in each department and has, on the provider side, a CM (Contract Manager) 21, a CK (Contract Keeper) 22, one or more server 23, an operator terminal 24, and a provider terminal 31. The CM 21, CK 22, server 23, and operator terminal 24 are installed within a data center.

The client 12 is connected to the CC 11. The CC 11 is connected to the CM 21 and CK 22 through a network 1. The CC 11 and client 12 may be incorporated in one apparatus. The planning terminal 13 is connected to the CM 21 through the network 1. The terminal 14 for each department is connected to the planning terminal 13. The CM 21 is connected to the CK 22 and server 23. The CK 22 is connected to the server 23. The operator terminal 24 is connected to the CM 21 and server 23.

The terminal 14 for each department determines service utilization plan in each department on the consumer side. The planning terminal 13 compiles the service utilization plan on the consumer side. The client 12 executes a client program to access the Web service. The operator terminal 24, which is operated by an operator on the provider side, monitors and controls the server 23. The provider terminal 31, which is operated by a person in charge on the provider side, inputs a price list and the like.

Next, operation of the Web service system according to the present embodiment will be described.

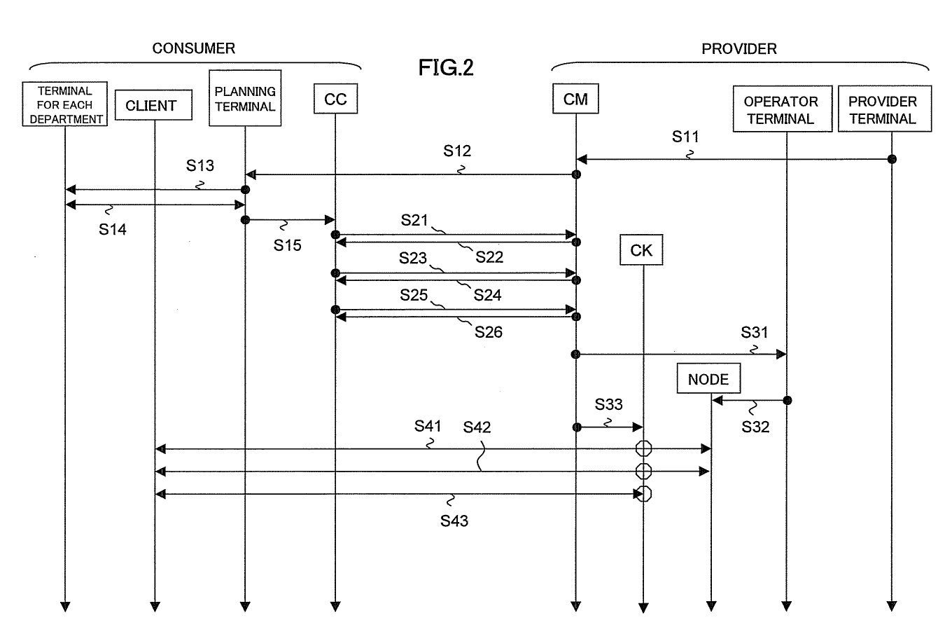

FIG. 2 is a sequence diagram depicting an example of operation of the Web service system according to the present embodiment. This sequence diagram depicts operations of the terminal 14 for each department, client 12, planning terminal 13, and CC 11 on the consumer side and operations of the CM 21, CK 22, node, operator terminal 24, and provider terminal 31 on the provider side. On the provider side, the node denotes one or more servers 23 allocated to a service. The Web service system performs Web service reservation processing (S11 to S31) and Web service execution processing (S32 to S43).

Next, the Web service reservation processing will be described.

The provider terminal 31 transmits a price list created by a sales representative on the provider side to the CM 21 (S11). The CM 21 transmits the received price list to the planning terminal 13 (S12). The planning terminal 13 transfers the received price list to the terminal 14 for each department (S13).

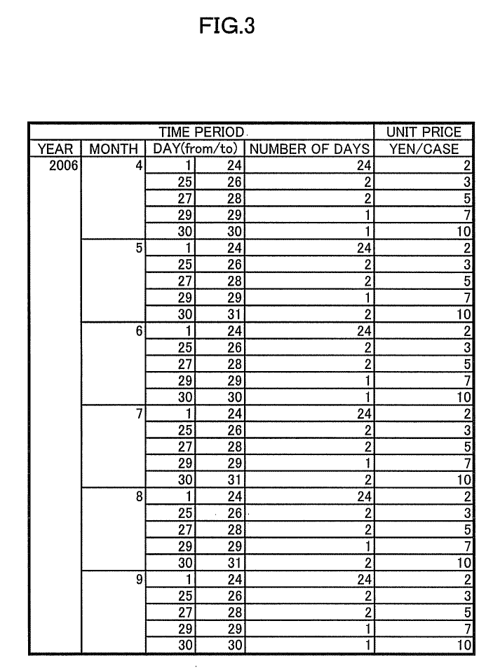

A description will be given here of the price list. FIG. 3 is a table depicting an example of the content of the price list according to the present embodiment. This price list depicts the price of the abovementioned “stamp” service of “TSService”. The price list depicts a list of segments of service use time period and unit price of the service for each time period segment. In the “time period” item, the date (year, month and day) representing the service start day and service end day and the number of days from the service start day to service end day are recorded. Further, the time period segment is classified according to the level of the Web service request amount (for example, the time segment is classified into “off season” and “on season” groups). In the “unit price” item, price (yen/case) per one electronic receipt (one request) is recorded. Further, the list may include a maximum number of electronic receipts which represents the upper limits of the number of electronic receipts that can be reserved. The unit price may be classified into reservation time unit price representing the price to be paid at the reservation time and execution time price unit representing the price to be paid at the execution time.

Then, a person in charge of each department designs service utilization plan of his or her own department based on the received price list and past performance table and the terminal 14 for each department notifies the planning terminal 13 of the service utilization plan (S14).

The planning terminal 13 then compiles the utilization plans from respective departments to thereby create a utilization plan table and transmits the table to the CC 11 (S15).

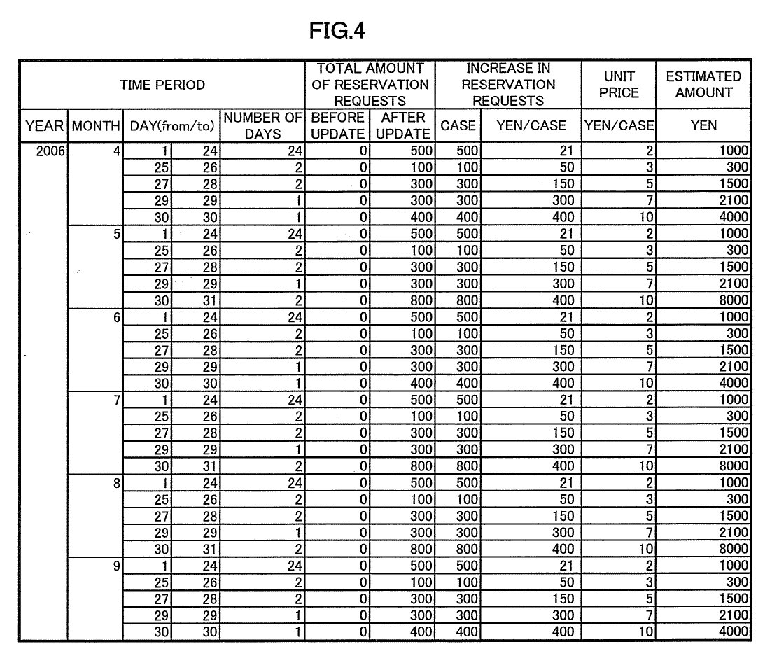

A description will be given here of the utilization plan table. FIG. 4 is a table depicting a first example of the utilization plan table according to the present embodiment. This utilization plan table depicts a list of segments of service use time period, as well as, total amount of reservation requests, increase in reservation requests, unit price, and estimated amount for each time period segment.

In the “time period” item, the same values as those in the price list are recorded. The “total amount of reservation requests” item represents the total number of Web service requests to be reserved, and “increase in reservation requests” item represents the number of Web service requests to be newly reserved. In the “total amount of reservation requests” item, the total amount of reservation requests before update [case] representing the total amount of requests in a past utilization plan table and total amount of reservation requests after update [case] representing the total amount of requests up to this time are recorded. In the “increase in reservation requests” item, increase in the amount of reservation requests [case] and increase in the amount of reservation requests per one day [case/day] are recorded. In the “unit price” item, the same values as those in the price list are recorded. In the “estimated amount” item, increase in the charge to be paid for the service (increase in reservation requests x unit price) is recorded. The utilization plan table of FIG. 4 is a utilization plan table that has been created first. Therefore, all values for the total amount of reservation requests before update are 0, and the total amount of reservation requests after update and increase in reservation requests are equal to each other.

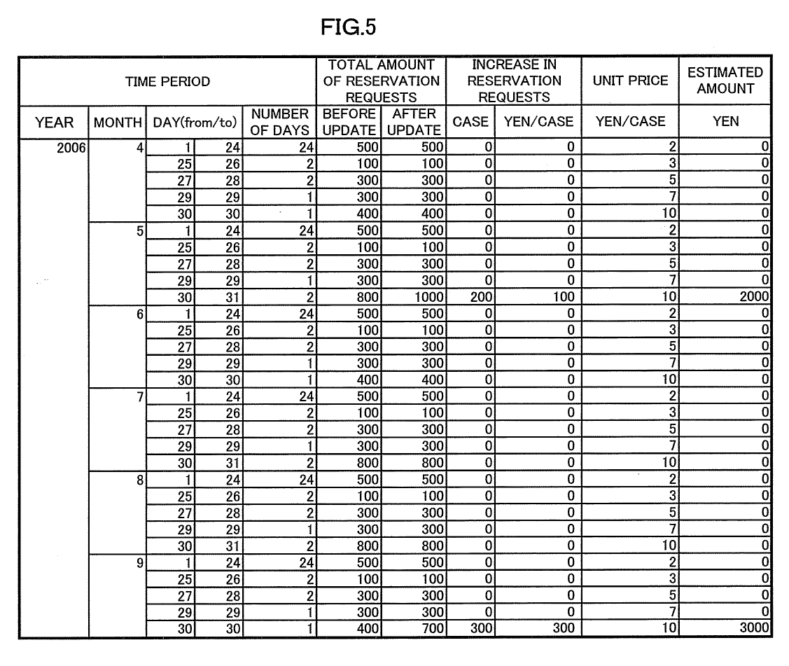

The planning terminal 13 can update the utilization plan table even after transmitting the utilization plan table to the CC 11 and transmit the latest utilization plan in the form of a difference from the immediately preceding utilization plan table. FIG. 5 is a table depicting a second example of the utilization plan table according to the present embodiment. The utilization plan table of FIG. 5 is one that has been created after the utilization plan table of FIG. 4. Therefore, the total amount of reservation requests before update of FIG. 5 corresponds to the total amount of reservation requests after update of FIG. 4, and the total amount of reservation requests after update of FIG. 5 is a value obtained by adding the increase in the number of reservation requests to the total amount of reservation requests before update.

The CC 11 then starts electronic negotiation with the CM 21 for service reservation (S21). The CM 21 prepares authentication processing and the like according to a specification of the electronic negotiation (S22). The CC 11 transmits a reservation request to the CM 21 (S23, S25). Upon receiving the reservation request, the CM 21 performs reservation determination processing to make determination whether it accepts or rejects the reservation request based on a reservation condition and received reservation request and reservation reply processing to transmit a reservation reply to the CC 11 in accordance with a result of the determination (S24, S26).

Each of the reservation request and reservation reply is a machine-readable agreement conforming to Agreement document format defined in a specification (e.g., GGF WS-Agreement specification) of the electronic negotiation and is described in XML (Extensible Markup Language) or the like. When a reservation reply indicating “acceptance” is transmitted from the CM 21 to CC 11, the relevant agreement is completed. In this agreement, the provider side represents to the consumer side that it can reject the Web service request different from the reserved request condition.

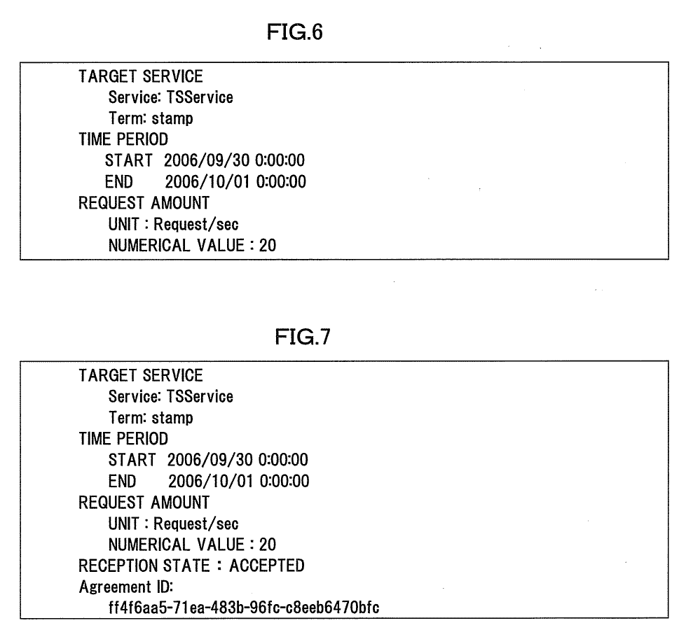

A description will be given here of the content of the reservation request. FIG. 6 is a view depicting an example of the content of the reservation request according to the present embodiment. The reservation request describes “target service”, “reservation time period”, and “request amount”. The “target service” is represented by service type (service) and function (term). In this example, the service type is TSService, and function is stamp. The “reservation time period” is represented by start time and end time. The “request amount”, which is a Web service request amount (processing amount), is represented by unit and numerical value. In this example, the unit is RPS (Request/sec), and numerical value is 20.

A description will next be given of the content of the reservation reply. FIG. 7 is a view depicting an example of the content of the reservation reply according to the present embodiment. The reservation reply describes “target service”, “reservation time period”, “request amount”, and “reception state”. Each of the “target service”, “reservation time period”, and “request amount” has the same value as that of the corresponding reservation request. The “reception state” assumes two values of “accepted” indicating that a reservation request has been accepted and “rejected” indicating that a reservation request has been rejected depending on the result of the reservation determination processing. In the case where a reservation request has been accepted, a reservation described in the reservation request is made and thereby agreement is completed. Then, an agreement ID is given to the agreement by the CM 21 and is described in the reservation reply. In this example, the “reception state” is “accepted” and thus the agreement ID has been described.

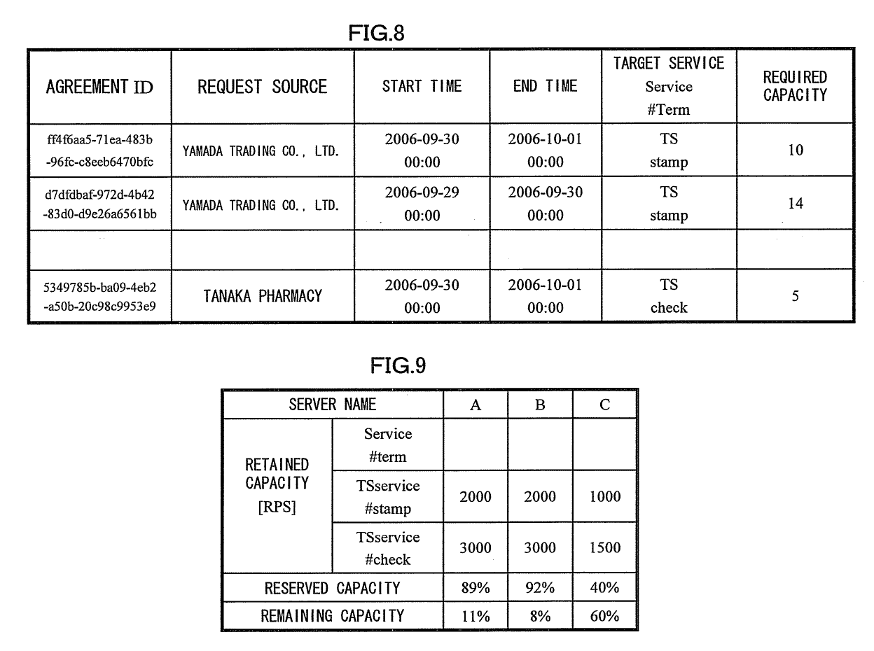

The CM 21 retains a provider reservation information table and, when the reservation is established, registers information of the established reservation in the provider reservation information table. FIG. 8 is a table depicting an example of the content of the provider reservation information table according to the present embodiment. The provider reservation information table has provider reservation information which is information relevant to each established reservation. The provider reservation information has items of “agreement ID”, “request source”, “start time”, “end time”, “target service”, “required capacity”. The “agreement ID” has the same value as that of the “agreement ID” in the reservation reply. The “reply source” is the name of the consumer side. The reservation time period (“start time” and “end time”) and “target service” have the same value as those described in the accepted reservation request. The “required capacity” has the same value as that of the “request amount” described in the accepted reservation request and represents the processing capacity required for executing a reserved service.

The CM 21 sets the reservation time period described in the received reservation request as a coverage time period and, based on the coverage time period and provider reservation information table, creates a server information table. FIG. 9 is a table depicting an example of the content of the server information table according to the present embodiment. The server information table represents server information relevant to each server 23. The server information represents a state of the server 23 in the coverage time period and has items of “retained capacity [RPS]”, “reserved capacity [%]”, and “remaining capacity [%]”. The “retained capacity” is a value representing the maximum value of the processing capacity of the server by the amount of Web service requests on a per-service basis. In this example, stamp of TSService and check of TSService are set as the target service. The “reserved capacity” is a value representing the total sum of the processing capacities that have been reserved in the coverage time period as a ratio [%] relative to the retained capacity. The “remaining capacity”, which is obtained by (100%—reserved capacity), represents the processing capacity that has not been reserved as a ratio [%] relative to the retained capacity.

The CM 21 then determines whether the content of the reservation request satisfies the reservation condition. In the case where the reservation condition is satisfied, the CM 21 registers the content of the reservation request as the provider reservation information and sends back a reservation reply indicating “accepted” to the client 12. On the other hand, in the case where the reservation condition is not satisfied, the CM 21 sends back a reservation reply indicating “rejected” to the client 12. The reservation condition specifies that the request amount in the reservation request be not more than the remaining capacity in the server information table. That is, in the case where the request amount of the received reservation request exceeds the remaining capacity, the CM 21 sends back the reservation reply indicating “rejected”.

Alternatively, in the case where reservation preparation time period is set and where the CM 21 sets a value obtained by (start time of reservation time period in reservation request—reservation preparation time period) as reservation deadline of the reservation request, the reservation condition may specify that the current time falls within the reservation deadline of the reservation request. That is, in the case where the current time at the time point when receiving the reservation request passes the reservation deadline set for the reservation request, the CM 21 sends back a reservation reply indicating “rejected”.

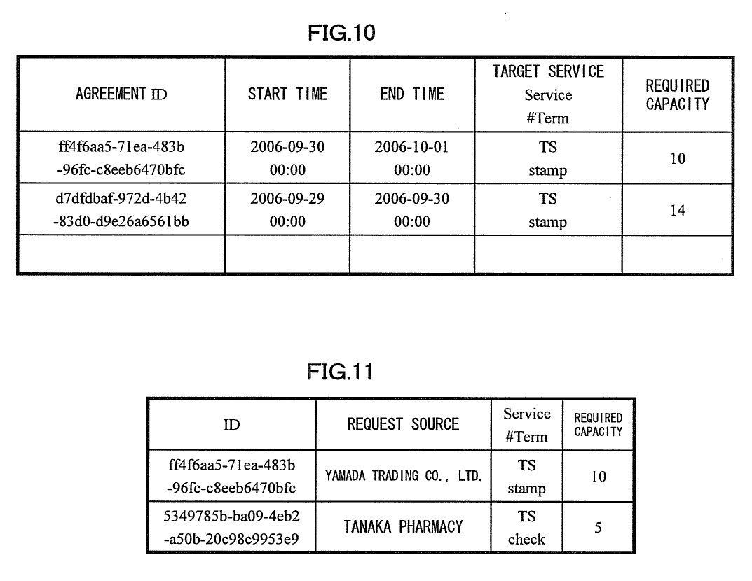

The CC 11 retains a consumer reservation information table and, when receiving a reservation reply indicating “accepted”, registers the content included in the reservation reply in the consumer reservation information table. FIG. 10 is a table depicting an example of the content of the consumer reservation information table according to the present embodiment. The consumer reservation information table has consumer reservation information which is information relevant to each reservation reply indicating “accepted”. The consumer reservation information has items of “agreement ID”, reservation time period (“start time” and “end time”), “target service”, and “required capacity” which have the same values as those of the provider reservation information.

The CM 21 then transmits the provider reservation information to the operator terminal 24 (S31). The operator refers to the provider reservation information displayed on the operator terminal 24 to determine allocation of the nodes.

Next, the Web service execution processing will be described.

According to given provider reservation information that has been received from the CM 21, the operator terminal 24 allocates, as nodes, the number of the servers 23 that can assure the required capacity corresponding to the relevant provider reservation information by the start time of the reservation time period thereof (S32). Further, in the case where the reservation time period of the relevant provider reservation information has ended, the operator terminal 24 releases the number of nodes corresponding to the required capacity of the relevant provider reservation information.

Then, at the start time of the reservation time of the relevant provider reservation information, the CM 21 transmits the relevant provider reservation information to the CK 22, and the CK 22 registers the content of the received provider reservation information in a passage determination information table (S33). In the case where the current time has passed the end time of the reservation time period described in passage determination information, the CM 21 deletes the passage determination information from the passage determination information table.

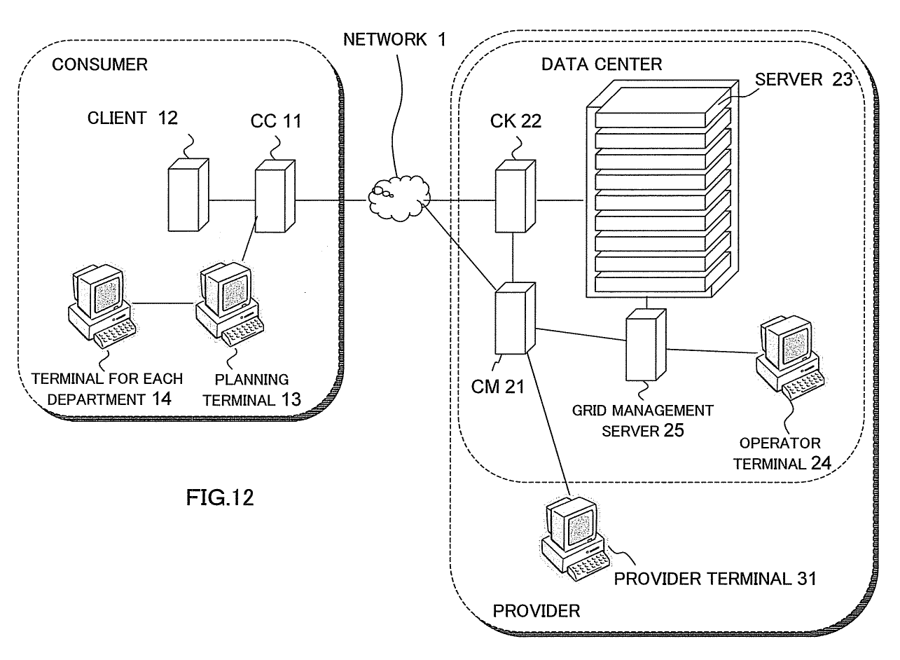

A description will be given here of the passage determination information table. FIG. 11 is a table depicting an example of the content of the passage determination information table according to the present embodiment. The passage determination information table has passage determination information relevant to each received provider reservation information. The passage determination information is information for the CK 22 to determine the Web service request and has items of “agreement ID”, “request source”, “target service”, and “required capacity”, which have the same values as those of the provider reservation information. Further, the passage determination information table has only passage determination information whose reservation time period includes the current time.

Then, the client 12, uses a client program of the Web service to transmit a Web service request to a node through the CC 11 and CK 22. In the case where the Web service request received from the client 12 satisfies an added condition, the CC 11 acquires the corresponding agreement ID from the client reservation information table and adds the agreement ID to the Web service request. Here, the added condition specifies that client reservation information in which the target service is the same as that specified in the Web service request and in which the reservation time period includes the current time exist in the client reservation information table.

The CK 22 receives the Web service request from the CC 11 and compares the Web service request with passage determination information table. In the case where the Web service request satisfies the passage condition, the CK 22 transfers the Web service request to the node (S41, S42). In the case where the Web service request does not satisfy the passage condition, the CK 22 does not transfer the Web service request to the node but transmits a notification representing “rejected” to the client 12 (S43). Here, the passage condition specifies that the passage determination information whose agreement ID is the same as the agreement ID of the received Web service request exist in the passage determination information table, and that the Web service request amount corresponding to the agreement ID be not more than the required capacity in the passage determination information.

Note that not only a single passage condition, but also a plurality of passage conditions may be set. In this case, different unit prices may be set for a plurality of passage conditions.

The node executes the service according to the Web service request received from the CK 22 and transmits a result of the execution to the client 12. The CK 22 transmits the information of the Web service request that the CK 22 allows to pass therethrough to the CM 21. The CM 21 tallies the information of the Web request service for each request source, each target service, and each time period segment and records it as an achievement information table. This achievement information table is used when the provider side charges the consumer side for a service fee.

According to the present embodiment, the CK 22 can reject a Web service request that does not satisfy a reserved condition. Further, by enabling the rejection of unfavorable Web service request, it is possible to prevent overload on the node, thereby enhancing stability of the system. Further, a reservation process concerning the Web service request amount can be automatically performed. Therefore, man-hour can significantly be reduced, making it possible to cope with a large number of consumers or frequent updates of reservation concerning the Web service request amount. Further, by setting the reservation preparation time period, it is possible to take some measures before the start of the reservation time period such as enhancement of facility.

Comparing with a Web service system using an autonomous system, the Web service system according to the present embodiment is easier to control and, further, facility arrangement and cost calculation are also easier.

### Second Embodiment

In the present invention, a Web service system which includes servers laid out in a grid system will be described.

A configuration of a Web service system according to the present embodiment will first be described.

FIG. 12 is a block diagram depicting an example of a configuration of the Web service system according to the present embodiment. In FIG. 12, the same reference numerals as those in FIG. 1 denote the same or corresponding parts as those in FIG. 1, and the descriptions thereof will be omitted here. As compared to FIG. 1, it can be seen that the Web service system of FIG. 12 newly includes a grid management server 25. The CM 21 is connected to the CK 22 and grid management server 25. The operator terminal 24 is connected to the grid management server 25. A server group including a plurality of servers 23 constitutes a grid system and is controlled by the grid management server 25. This server group can be allocated by the grid management server 25 as a node other than one of the Web service according to the present embodiment.

Next, operation of the Web service system according to the present embodiment will be described.

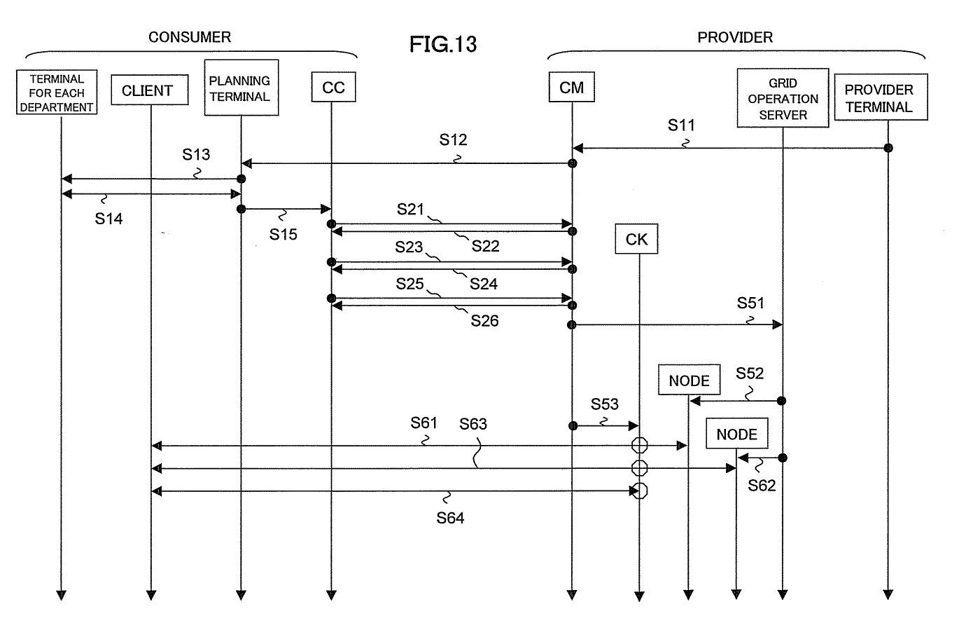

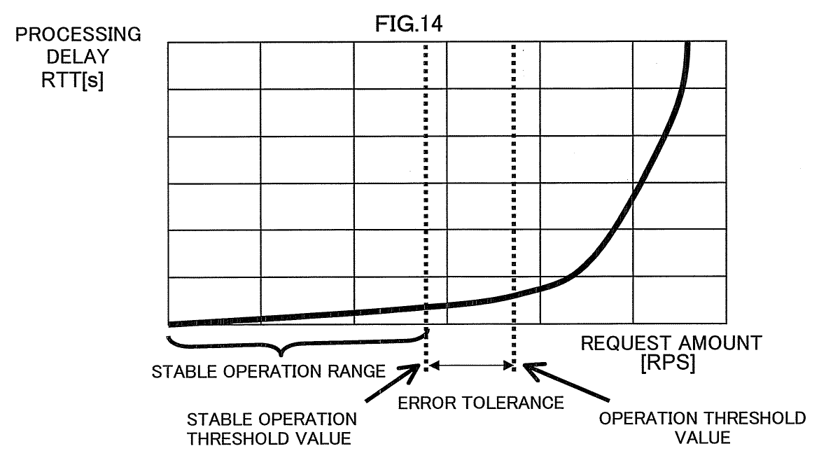

FIG. 13 is a sequence diagram depicting an example of operation of the Web service system according to the present embodiment. In FIG. 13, the same reference numerals as those in FIG. 2 denote the same or corresponding parts as those in FIG. 2, and the descriptions thereof will be omitted here. As compared to FIG. 2, it can be seen that FIG. 13 depicts the operation of the grid management server 25 in place of the operation of the operator terminal 24. The Web service system performs Web service reservation processing (S11 to S51) and Web service execution processing (S52 to S64).

Next, the Web service reservation processing will be described.

The operations in steps S11 to S26 are the same as those in the first embodiment. Then, in the case where the content of a reservation request satisfies a reservation condition, the CM 21 performs server reservation processing for the grid management server 25. The server reservation processing is reservation processing for allocation of a server 23 that satisfies the reservation condition immediately before start of the reservation time period (S51).

Next, the Web service execution processing will be described.

According to the server reservation processing, the grid management server 25 deploys the reserved server 23 as a node of the grid system at the time immediately before the start of the reservation time period (S52, S62). When the reservation time period has ended, the grid management server 25 releases the allocated node.

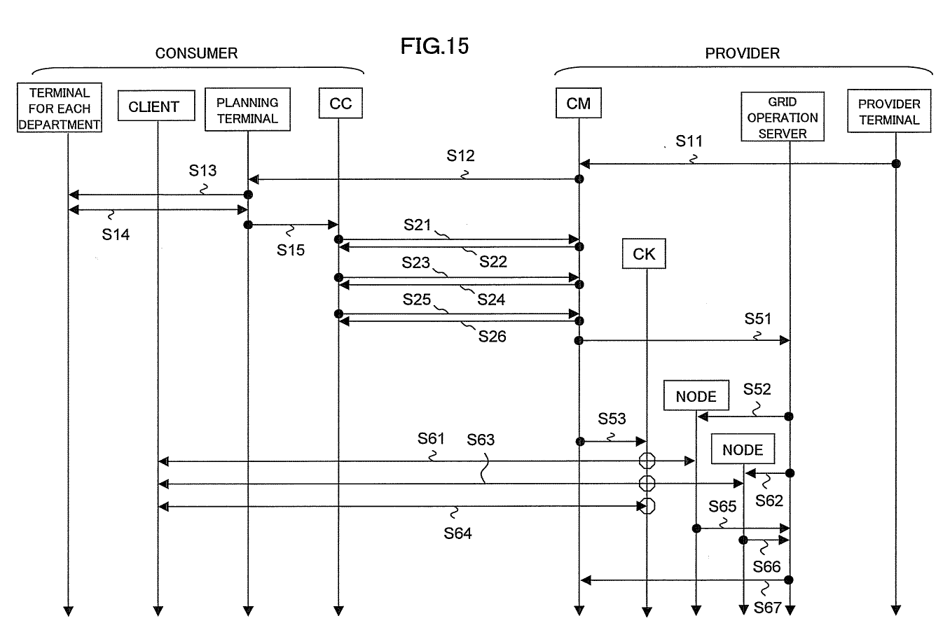

In the server reservation processing, the CM 21 uses a stable operation threshold value previously set for each server 23 to determine the number of the servers 23 to be reserved. The stable operation threshold value is equal to the above-mentioned retained capacity. FIG. 14 is a graph depicting an example of a service profile according to the present embodiment. The service profile is a graph representing, on a coordinate system, the amount of Web service requests (horizontal axis [RPS]) and processing delay (RTT: Round Trip Time) (vertical axis [sec]) as a curved line. Further, the service profile is measured by a performance test performed before start of the operation of the Web service system. It can be seen from the service profile that at the time point when the Web service request amount exceeds the operation threshold value, the processing delay rapidly increases. Further, an error tolerance, which is a tolerance of error between the performance test time and actual operation time, is defined in this service profile and thus the stable operation threshold value (operation threshold value−error tolerance) is defined so that the Web service request amount does not exceed the operation threshold value.

In the server reservation processing, the CM 21 reserves the servers 23 based on the server information table such that the Web service request amount for each server 23 becomes not more than the stable operation threshold value (i.e., the Web request amount for each server 23 falls within a stable operation range). For example, assuming that the stable operation threshold vales of all the servers 23 are the same, the CM 21 reserves the smallest integer number of servers 23 but not less than a value obtained by dividing the total sum of required capacities to be reserved by the stable operation threshold value. More specifically, in the case where a first server 23 is reserved by a first reservation and the required capacity in the reservation time period of a second reservation exceeds the stable operation threshold value of the first server 23, a second server 23 is additionally reserved. Consequently, the grid management server 25 allocates the first server 23 at the start time of the first reservation (S52) and allocates the second server 23 at the start time of the second reservation (S62).

The operations in steps S53, S61, S63, and S64 are the same as those in steps S33, S41, S42, and S43 in the first embodiment, respectively.

According to the present embodiment, the grid management server 25 can automatically allocate a node in accordance with a reserved required capacity. This reduces a load on the operator and eliminates estimation error of the facility arrangement, thereby enhancing stability of the Web service system. Further, the grid management server 25 can allocate a required node at a required timing, thereby enhancing the utilization ratio of the server 23.

The plurality of servers 23 may be provided at a location other than the data center and may be provided at a plurality of locations in a distributed manner.

### Third Embodiment

In the present embodiment, a Web service system which includes servers laid out in a grid system and controls a stable operation threshold value for each server will be described.

A configuration of the Web service system according to the present embodiment is the same as that according to the second embodiment.

Operation of the Web service system according to the present embodiment will be described.

FIG. 15 is a sequence diagram depicting an example of operation of the Web service system according to the present embodiment. In FIG. 15, the same reference numerals as those in FIG. 13 denote the same or corresponding parts as those in FIG. 13, and the descriptions thereof will be omitted here. As compared to FIG. 13, it can be seen that steps S65 to S67 are additionally performed in FIG. 15.

As described above, the initial value is set lower than a result of the test performed before the actual operation for the purpose of allowance. The operations in step S11 to S64 are performed in the similar manner as the second embodiment. Then, the grid management server 25 acquires a load index from a node that is in operation (S65, S66) and transmits the acquired load index to the CM 21 (S67). Examples of the load index (load information) include a CPU utilization, network usage, memory usage, and the like. Then, the CM 21 resets the error tolerance and stable operation threshold value based on the actual measurement values concerning the processing capacities, such as values in the provider reservation information table, values in the achievement information table, and load index. The CM 21 then compares a given actual measurement value concerning the processing capacity and current stable operation threshold value. In the case where the stable operation threshold value is considerably larger than the actual measurement value concerning the processing capacity (for example, the actual processing delay with respect to the actual Web service request amount is smaller than the processing delay obtained by the service profile), the CM 21 increases the stable operation threshold value. On the other hand, in the case where the stable operation threshold value is considerably smaller than the actual processing capacity (for example, the actual processing delay with respect to the actual Web service request amount is larger than the processing delay obtained by the service profile), the CM 21 reduces the stable operation threshold value. In the case where the CM 21 has reset the stable operation threshold value, it performs the server reservation processing once again.

In a conventional Web service system, it has been necessary to set the error tolerance to a larger value due to some undetermined factor for the purpose of allowance. According to the present embodiment, even in the case where the error tolerance has been set to a considerably larger value before start of the actual operation, review of the error tolerance can be made during the actual operation to thereby reduce the error tolerance to an adequate value. Accordingly, the stable operation threshold value becomes larger to reduce the facility arrangement, thereby reducing operation cost. On the other hand, in the case where the load index during the actual operation time becomes worse, the error tolerance is made larger to reduce the stable operation threshold value. This suppresses the Web service request amount to be reserved afterward, thereby prioritizing the stability of the Web service system.

### Fourth Embodiment

In the present embodiment, a Web service system in which the agreement ID is added to plurality of protocol layer information in the Web service request transmitted from a consumer to a provider will be described.

In the case where the Web service uses SOAP in the above embodiments, the CC 11 adds the agreement ID in SOAP envelope of the Web service request, and the CK 22 detects the agreement ID added in the SOAP envelope. In this case, the CK 22 needs to perform syntax analysis of XML describing the SOAP envelope, which increases the load on the CK 22.

The configuration of the Web service system according to the present invention is the same as that of the first embodiment except that the CK 22 is realized using a layer 7 switch. The operation of the Web service system according to the present embodiment is the same as that of the first embodiment except for the operation of CC 11 and CK 22 in steps S41, S42, and S43.

Here, operation of the layer 7 switch will be described by taking a conventional load balancer constituted by the layer 7 switch as an example.

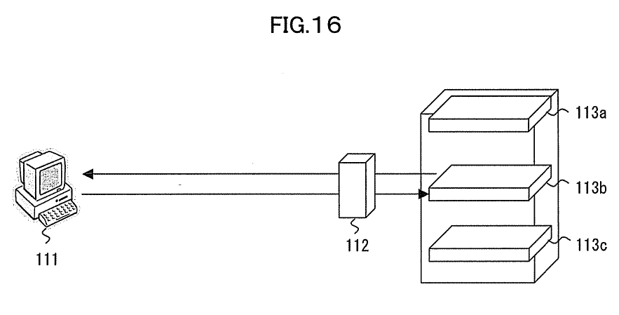

FIG. 16 is a block diagram depicting an example of operation of a conventional load balancer. A load balancer 111 is connected to a client 112 and a plurality of servers 113a, 113b, and 113c to relay communication between the client 112 and plurality of servers 113a, 113b, and 113c. The client 112 transmits a first request to the server, and the server 113a that has received the request transmits a replay into which cookie has been inserted to the client 112. The replay transmitted at this time is, e.g., as follows.

HTTP/1.1 200 OK
Set-Cookie: Customer=“WILE_E_COYOTE”;

The client 112 that has received the cookie inserts the cookie into a series of http requests to be transmitted afterward to the server. The request transmitted at this time is added with, e.g., the following header.

POST /acme/pickitem HTTP/1.1
Cookie: Customer=“WILE_E_COYOTE”;

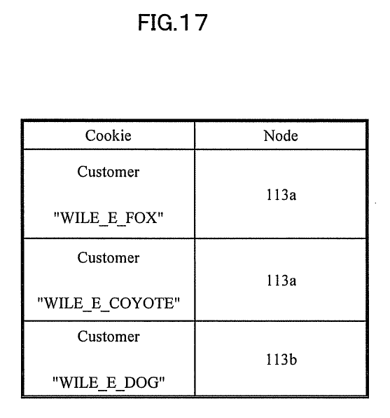

The load balancer 111 extracts the cookie from the request and reply to thereby sort the request including the cookie that has been received from the client 112 to a corresponding server 113a based on the extracted cookie. FIG. 17 is a table depicting an example of the cookie table retained by the conventional load balancer. The load balancer 111 retains the identifier of a node that has issued cookie as represented by the cookie table. The load balancer 111 refers to the cookie table every time a request having a cookie header passes therethrough to determine a destination node.

The CK 22 in the present embodiment uses the passage determination information table in place of the abovementioned cookie table and uses the agreement ID in place of the cookie to thereby easily utilize the layer 7 switch.

In steps S41, S42, and S43, the client 12 uses a client program of the Web service to transmit a Web service request to a node through the CC 11 and CK 22. In the case where the Web service request received from the client 12 satisfies an added condition, the CC 11 acquires the corresponding agreement ID from the client reservation information table and adds the agreement ID in the SOAP envelope of the Web service request. The CC 11 adds the agreement ID also to an HTTP header outside SOAP envelop of the Web service request.

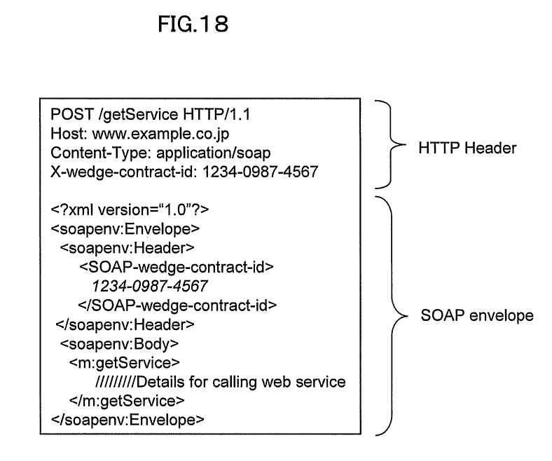

FIG. 18 is a view depicting an example of the Web service request according to the present embodiment. In FIG. 18, the agreement ID is inserted into the SOAP header as “SOAP-wedge-contract-id” and inserted into the HTTP header as “X-wedge-contract-id”.

Upon receiving the Web service request from the CC 11, the CK 22 compares the Web service request with the passage determination information table. In the case where the Web service request satisfies the passage condition, the CK 22 transfers the Web service request to the node (S41, S42). In the case where the Web service request does not satisfy the passage condition, the CK 22 does not transfer the Web service request to the node but transmits a notification representing “rejected” to the client 12 (S43). Here, the passage condition specifies that the agreement ID exists in at least one of the HTTP header and SOAP envelope of the received Web service request, and that the Web service request amount corresponding to the agreement ID is not more than the required capacity in the passage determination information.

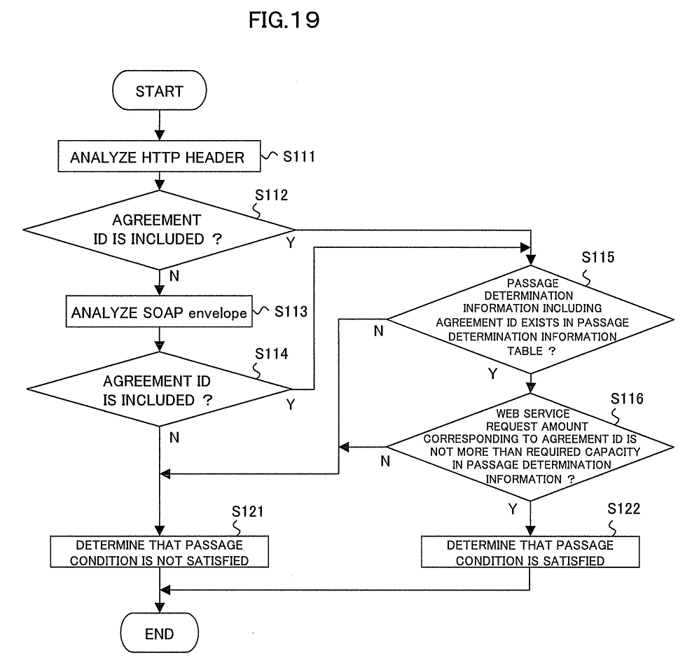

Next, operation of the CK 22 in steps S41, S42, and S43 will be described. FIG. 19 is a flowchart depicting an example of operation of the CK according to the present embodiment. The CK 22 analyzes the HTTP header of the received Web service request (S11) to determine whether the agreement ID in the passage determination information table is included in the HTTP header (S112). In the case where the agreement ID is included (Yes in step S112), the flow shifts to step S115. In the case where the agreement ID is not included (No in step S112), the CK 22 analyzes the SOAP envelope of the received Web service request (S113) to determine whether the agreement ID in the passage determination information table is included in the SOAP envelop (S114). In the case where the agreement ID is included (Yes in step S114), the flow shifts to step S115.

In the case where the agreement ID is not included (No in S114), the CK 22 determines that the passage condition is not satisfied (S121), and the flow is ended.

In the case where the agreement ID is included in step S112 or S114, the CK 22 determines whether the passage determination information including the agreement ID exists in the passage determination information table (S115). In the case where the passage determination information including the agreement ID does not exist in the passage determination information table (No in S115), the flow shifts to step S121. In the case where the passage determination information including the agreement ID exists in the passage determination information table (Yes in S115), the CK 22 determines whether the Web service request amount corresponding to the agreement ID is not more than the required capacity in the passage determination information (S116). In the case where the Web service request amount corresponding to the agreement ID is more than the required capacity (No in S116), the flow shifts to step S121. In the case where the Web service request amount corresponding to the agreement ID is not more than the required capacity (Yes in S116), the CK 22 determines that the passage condition is satisfied, and the flow is ended.

HTTP syntax is simpler than XML syntax representing the SOAP envelope, so that less load is required to detect the agreement ID in the HTTP header than to detect the agreement ID in the SOAP envelope. In particular, the layer 7 switch is designed to effectively perform HTTP processing, so that the processing speed of the CK 22 can be increased.

The CC 11 adds the agreement ID both to the SOAP envelope and HTTP header of the Web service request in the present embodiment. However, according to the abovementioned operation of the CK 22, even in the case where a CC that does not have a function of adding the agreement ID to the HTTP header exists, it is possible to transfer a Web service request to a node as long as the agreement ID has been added at least to the SOAP envelope of the Web service request.

Further, although the SOAP is used as a protocol for calling the Web service, and HTTP is used as a protocol for transmitting/receiving data in the lower layer than the SOAP in the above embodiment, any other suitable protocol may be used in place of the SOAP and HTTP. An example of a protocol that can be used in place of the SOAP includes CORBA (Common Object Request Broker Architecture) over http, RST, etc. Further, one or more of the abovementioned embodiments may be combined with the present embodiment.

According to the present embodiment, the CC 11 adds the agreement ID also to the HTTP header of the Web service request, and CK 22 detects the agreement ID in the HTTP header of the Web service request. With this configuration, the processing load of the CK 22 can be reduced, whereby the processing speed thereof can be increased. Further, by utilizing the existing layer 7 switch to constitute the CK 22, cost can be reduced.

The CC 11, CM 21, and CK 22 according to the abovementioned embodiment can easily be applied to an information communication apparatus to thereby increase performance thereof. Examples of the information communication apparatus include a server, a router, a switch, and the like.

Further, it is possible to provide a program that allows a computer constituting the Web service system to execute the above steps as a Web service control program. By storing the above program in a computer-readable storage medium, it is possible to allow the computer constituting the Web service system to execute the program. Further, it is possible to provide a program that allows a computer constituting the CC to execute the above steps as a relay program. By storing the above program in a computer-readable storage medium, it is possible to allow the computer constituting the CC to execute the program.

The computer-readable medium mentioned here includes: an internal storage device mounted in a computer, such as ROM or RAM, a portable storage medium such as a CD-ROM, a flexible disk, a DVD disk, a magneto-optical disk, or an IC card; a database that holds computer program; another computer and database thereof.

A management step corresponds to steps S22, S24, and S26 in the embodiments. An adaptation determination step and a transfer step correspond to the processing performed by the CK 22 in steps S41 to S43 in the embodiments.

A reservation request step corresponds to steps S21, S23, and S25 in the embodiments. A transmission step corresponds to the processing performed by the CC 11 in steps S41 to S43 in the embodiments.

A management section corresponds to the CM 21 in the embodiments. An adaptation determination section and a transfer section correspond to the CK 22 in the embodiments.

According to the present invention, it is possible to control the amount of Web service requests to be accepted based on reservation.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A computer readable storage medium storing a Web service control program that allows a computer to execute a process comprising:
receiving from a consumer of a reservation request for a reservation which reserves the Web service and defines a condition for Web service requests for the Web service;
acquiring a state of a server that can execute the Web service;
determining whether or not to accept the reservation according to the condition and the state of the server;
accepting the reservation when it is determined to accept the reservation;
transmitting to the consumer, when the reservation is accepted, a reply including a reservation identifier indicating the accepted reservation;
when receiving from the consumer a Web service request which includes first information based on a first communication protocol and second information based on a second communication protocol, detecting the reservation identifier in the second information to determine according to result of the detecting whether or not the Web service request conforms to the accepted reservation, a layer of the second communication protocol being lower than a layer of the first communication protocol; and
transferring the received Web service request to the server when the received Web service request is determined to conform to the accepted reservation.

2. The computer readable storage medium according to claim 1, wherein
when the reservation identifier is not detected in the second information, the detecting detects the reservation identifier in the first information to determines according to result of the detecting whether or not the Web service request conforms to the accepted reservation.

3. The computer readable storage medium according to claim 1, wherein
the receiving receives the reservation request according to an electronic negotiation process,
the transmitting transmits the reply indicating acceptance or rejection of the reservation according to the electronic negotiation process, and
the reply indicating the acceptance includes the reservation identifier indicating the accepted reservation.

4. The computer readable storage medium according to claim 1, wherein
the state of the server includes processing capacity of the server, and
when it is determined that the reservation can be accomplished with the processing capacity, the accepting accepts the reservation.

5. The computer readable storage medium according to claim 1, wherein
the condition includes at least one of a time period during which Web service requests to be transmitted from the consumer for the Web service and a processing amount of the Web service.

6. The computer readable storage medium according to claim 5, wherein
when the reservation identifier is detected in at least one of the first information and the second information and the received Web service request satisfies the condition,
the process determines that the received Web service request conforms to the accepted reservation.

7. The computer readable storage medium according to claim 1, wherein
the second communication protocol is HTTP, and
the second information is an HTTP header.

8. The computer readable storage medium according to claim 1, wherein
the condition includes a time period during which Web service requests to be transmitted from the consumer for the Web service and a processing amount of the Web service,
the state of the server includes a processing capacity of the server,
the processing capacity is not reserved in the time period, and
when the processing capacity is more than the processing amount, the process determines to accept the reservation.

9. The computer readable storage medium according to claim 8, wherein
the processing amount is the number of the Web service requests to be transmitted per unit time.

10. The computer readable storage medium according to claim 1, wherein
when the reservation identifier is detected in at least one of the first information and the second information, the process determines that the received Web service request conforms to the accepted reservation.

11. The computer readable storage medium according to calm 1, wherein
when it is determined that a received Web service request does not conform to the accepted reservation, the process rejects the received Web service request.

12. The computer readable storage medium according to claim 1, wherein
the detecting and the transferring are realized by a layer 7 switch.

13. The computer readable storage medium according to claim 1, wherein
the first communication protocol is one of SOAP, REST, and CORBA.

14. The computer readable storage medium according to claim 1, wherein
the first information is a message for calling the Web service.

15. A Web service control apparatus comprising:
a management section that receives from a consumer of a reservation request for a reservation which reserves the Web service and defines a condition for Web service requests for the Web service, acquires a state of a server that can execute the Web service, determines whether or not to accept the reservation according to the condition and the state of the server, and accepts the reservation when it is determined to accept the reservation;
a reservation notification section that transmits to the consumer, when the reservation is accepted, a reply including a reservation identifier indicating the accepted reservation;
a conformity determination section that detects, when receiving from the consumer a Web service request which includes first information based on a first communication protocol and second information based on a second communication protocol, a layer of the second communication protocol being lower than a layer of the first communication protocol, the reservation identifier in the second information to determine according to result of the detecting whether or not the Web service request conforms to the accepted reservation; and
a transfer section that transfers the received Web service request to the server when the received Web service request is determined to conform to the accepted reservation.

16. A Web service control method comprising:
receiving from a consumer of a reservation request for a reservation which reserves the Web service and defines a condition for Web service requests for the Web service;
acquiring a state of a server that can execute the Web service;
determining whether or not to accept the reservation according to the condition and the state of the server;
accepting the reservation when it is determined to accept the reservation;
transmitting to the consumer, when the reservation is accepted, a reply including a reservation identifier indicating the accepted reservation;
detecting, when receiving from the consumer a Web service request which includes first information based on a first communication protocol and second information based on a second communication protocol, a layer of the second communication protocol being lower than a layer of the first communication protocol, the reservation identifier in the second information to determine according to result of the detecting whether or not the Web service request conforms to the accepted reservation; and
transferring the received Web service request to the server when the received Web service request is determined to conform to the accepted reservation.
